(19) United States
(12) Patent Application Publication
(10) Pub. No.: US 2019/0129937 A1
(43) Pub. Date: May 2, 2019

(54) METHOD FOR CONTROLLING UNMANNED AERIAL VEHICLE, UNMANNED AERIAL VEHICLE AND CONTROLLING DEVICE

(71) Applicant: AUTEL ROBOTICS CO., LTD., Shenzhen (CN)

(72) Inventor: Ken ARGO, Shenzhen (CN)

(21) Appl. No.: 15/794,542

(22) Filed: Oct. 26, 2017

(51) Int. Cl. G06F 17/27; G08C 17/02; B64C 39/02

(52) U.S. Cl. CPC G06F 17/2785; G08C 17/02; H04L 67/12; B64C 39/024; G06F 17/2705

(57) ABSTRACT

The present disclosure provides a method for controlling an unmanned aerial vehicle, an unmanned aerial vehicle and a controlling device, where the method includes: obtaining, by the UAV, a controlling command based on a preconfigured file, wherein the preconfigured file is generated based on a natural language indicating an operation of the UAV; performing, by the UAV, the operation according to the controlling command. By implementing the method of the present disclosure, the user may save many months or longer in skills learning, thereby the control of the UAV is facilitated and the user experience is improved.

### TECHNICAL FIELD

The present disclosure relates to the technical field of artificial intelligences, and in particular, to a method for controlling an unmanned aerial vehicle, an unmanned aerial vehicle and a controlling device.

### BACKGROUND OF THE DISCLOSURE

An unmanned aerial vehicle (UAV), which is also referred to as an unmanned aerial aircraft, is currently controlled using a remote radio control device (e.g., a remote control box) following a physical control mechanism or through a set of call sequences executed, in order through calls of a computer programming interface (e.g., Objective-C, iOS SWIFT, JAVA, etc.)

However, these programming interfaces are only available to a developer familiar with devices, programing languages and tools needed to build a disclosure to execute the defined operations. Besides, as the development tools evolve or the programming interface to the UAV changes, additional time and efforts are needed to maintain functionalities of the UAV.

### SUMMARY OF THE DISCLOSURE

In view of defects in prior art, the present disclosure provides a method for controlling an unmanned aerial vehicle, an unmanned aerial vehicle and a controlling device, so as to save the user many months or longer in skills learning, facilitate the control of the UAV by the user and improve the user experience.

A first aspect of the present disclosure provides a method for controlling an unmanned aerial vehicle (UAV), including:

obtaining, by the UAV, a controlling command based on a preconfigured file, where the preconfigured file is generated based on a natural language indicating an operation of the UAV;

performing, by the UAV, the operation according to the controlling command.

In some embodiments of the disclosure, the obtaining, by the UAV, a controlling command based on a preconfigured file includes:

receiving, by the UAV, the preconfigured file from a controlling device;

parsing, by the UAV, the preconfigured file into the controlling command.

In some embodiments of the disclosure, the preconfigured file includes information about a characteristic parameter of the UAV and an instruction indicating the operation of the UAV; where the parsing, by the UAV, the preconfigured file into the controlling command includes:

extracting, by the UAV, the information about the characteristic parameter of the UAV and the instruction indicating the operation of the UAV from the preconfigured file;

converting, by the UAV, the extracted information about the characteristic parameter of the UAV and the extracted instruction indicating the operation of the UAV into the controlling command.

In some embodiments of the disclosure, the obtaining, by the UAV, a controlling command based on a preconfigured file includes: receiving, by the UAV, the controlling command from a controlling device, where the controlling command is obtained, by the controlling device, by parsing the preconfigured file in response to an acquired starting command.

In some embodiments of the disclosure, the preconfigured file is generated by a controlling device or the UAV based on inputs in natural language of a user.

In some embodiments of the disclosure, the inputs in natural language of the user are selected from the group consisting of voice inputs, text inputs and gesture inputs.

In some embodiments of the disclosure, the preconfigured file is generated by a controlling device or the UAV based on flight operations of the UAV controlled by a user.

In some embodiments of the disclosure, the preconfigured file is downloaded by a controlling device or the UAV in response to a downloading command from a user.

A second aspect of the present disclosure provides a method for controlling a UAV, including: acquiring, by a controlling device, a starting command from a user; in response to the starting command, transmitting, by the controlling device, a preconfigured file, where the preconfigured file is generated based on a natural language indicating an operation of the UAV.

A third aspect of the present disclosure provides a method for controlling a UAV, including: acquiring, by a controlling device, a starting command from a user; in response to the starting command, parsing, by the controlling device, a preconfigured file into a controlling command, where the preconfigured file is generated based on a natural language indicating an operation of the UAV; transmitting, by the controlling device, the controlling command to the UAV, so that the UAV performs the operation according to the controlling command.

A fourth aspect of the present disclosure provides a UAV, including: an airframe,

a transceiver coupled to the airframe and configured to obtain a controlling command based on a preconfigured file, where the preconfigured file is generated based on a natural language indicating an operation of the UAV; and

a processor coupled to the transceiver and configured to perform the operation according to the controlling command.

In some embodiments of the disclosure, the processor is further configured to:

receive the preconfigured file from a controlling device;

parse the preconfigured file into the controlling command.

In some embodiments of the disclosure, the preconfigured file includes information about a characteristic parameter of the UAV and an instruction indicating the operation of the UAV; where the processor is specifically configured to:

extract the information about the characteristic parameter of the UAV and the instruction indicating the operation of the UAV from the preconfigured file;

convert the extracted information about the characteristic parameter of the UAV and the extracted instruction indicating the operation of the UAV into the controlling command.

In some embodiments of the disclosure, the processor is specifically configured to: receive the controlling command from a controlling device, where the controlling command is obtained, by the controlling device, by parsing the preconfigured file in response to an acquired starting command.

A fifth aspect of the present disclosure provides a controlling device, including:

a shell;

a transceiver coupled to the shell and configured to acquire a starting command from a user and

a processor configured to parse a preconfigured file into a controlling command in response to the starting command, where the preconfigured file is generated based on a natural language indicating an operation of the UAV; where

the transceiver is further configured to transmit the controlling command to the UAV, so that the UAV performs the operation according to the controlling command.

In some embodiments of the disclosure, where the preconfigured file includes information about a characteristic parameter of the UAV and an instruction indicating the operation of the UAV; where

the processor is configured to:

extract the information about the characteristic parameter of the UAV and the instruction indicating the operation of the UAV from the preconfigured file;

convert the extracted information about the characteristic parameter of the UAV and the extracted instruction indicating the operation of the UAV into the controlling command.

In some embodiments of the disclosure, further including a device configured to perform the controlling command in a simulation mode.

In some embodiments of the disclosure, further including: a record device configured to record physical operations performed by a user, where the processor is configured to convert the physical operations into the natural language.

In some embodiments of the disclosure, further including a record device configured to record the operation performed by the UAV according to the controlling command.

In some embodiments of the disclosure, further including a memory configured to store the controlling command.

A sixth aspect of the present disclosure provides a controlling device, including: a non-transitory computer readable storage medium, including computer program codes when executed by a computer processor causing the compute processor to execute steps of the method according to the second aspect.

A seventh aspect of the present disclosure provides a controlling device, including: a non-transitory computer readable storage medium, including computer program codes when executed by a computer processor causing the compute processor to execute steps of the method according to the third aspect.

### BRIEF DESCRIPTION OF DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 is a schematic flowchart of a method for controlling an unmanned aerial vehicle (UAV) according to an embodiment of the present disclosure;

FIG. 2 is a schematic flowchart of a method for controlling a UAV according to an embodiment of the present disclosure;

FIG. 3 is a schematic flowchart of a method for controlling a UAV according to an embodiment of the present disclosure;

FIG. 4 is a structural diagram of a UAV according to an embodiment of the present disclosure;

FIG. 5 is a structural diagram of a controlling device according to an embodiment of the present disclosure;

FIG. 6 is a structural diagram of a controlling device according to an embodiment of the present disclosure;

FIG. 7 is a structural diagram of a UAV according to an embodiment of the present disclosure; and

FIG. 8 is a structural diagram of a controlling device according to an embodiment of the present disclosure.

### DESCRIPTION OF EMBODIMENTS

In the following detailed description, numerous specific details are set forth in order to provide a thorough understanding of the disclosure. However, it will be understood by those skilled in the art that the present disclosure may be practiced without these specific details. In other instances, well-known method, procedures, components and circuits have not been described in detail so as not to obscure the present disclosure.

Now a plurality of embodiments is described with reference to the drawings, where same reference numbers refer to same elements in the specification. To expose the present disclosure, in the following description, lots of details are elaborated so as to provide complete comprehensions to one or more embodiments. However, it is evident that the embodiments may not be implemented with these specific details. In other examples, structural diagrams are employed to illustrate common structures and devices, so as to describe one or more embodiments.

For the sake of clarity, several terms involved in the present disclosure are explained in the first place.

A preconfigured file may refer to a program including a set of statements, or an electrical file which is configured to save preconfigured programs. The preconfigured file may be accessed, edited, loaded and run on demand of a user. Besides, the preconfigured file may also be shared among different devices via different manners, for example, via a wireless network or an Ethernet network. For example, the preconfigured file may be transmitted directly using Wi-Fi or Bluetooth.

A controlling device may be a personal computer (PC), a tablet computer, or a terminal device, where the terminal device may be any one of the following devices: a smartphone, a mobile phone, a cellular phone, a cordless phone, a session initiation protocol (SIP) phone, a wireless local loop (WLL) station, a personal digital assistant (PDA), a handheld device capable of wireless communication, an on-board equipment, a wearable device, a computing device or other processing devices connecting to a wireless modem.

A natural language may refer to a language used to describe operations available to a UAV. Comparing with the programing language, the natural language is similar to our communicative language in terms of syntax and grammar rules. A user may use the natural language without any training in computer programming. For example, when a user wants to make the UAV fly to a pilot location, the user may simply use the natural language, such as an expression “fly UAV to a pilot location”. More details about the natural language will be explained later with reference to specific embodiments.

As described in the background, the UAV may be controlled through a set of call sequences executed, in order through calls of a computer programming interface. However, existing technologies require training in computer programming and the tools needed to create complete disclosures. Learning JAVA or iOS development systems can take many months or longer before a user can be successful in creating a program to control the UAV to perform flight operations. In addition, a fixed program can perform only what it has been designed for; adding more operations requires additional development in the same computer languages. As the development system evolves, changes may be required to maintain the functionality. In order to solve the aforementioned problem, the present disclosure provides a method for controlling an unmanned aerial vehicle (UAV), where the UAV may perform the operation according to the controlling command obtained based on a preconfigured file, where the preconfigured file is generated based on the natural language, so that a common user may create the preconfigured file in natural language rather than in programming language to control the UAV.

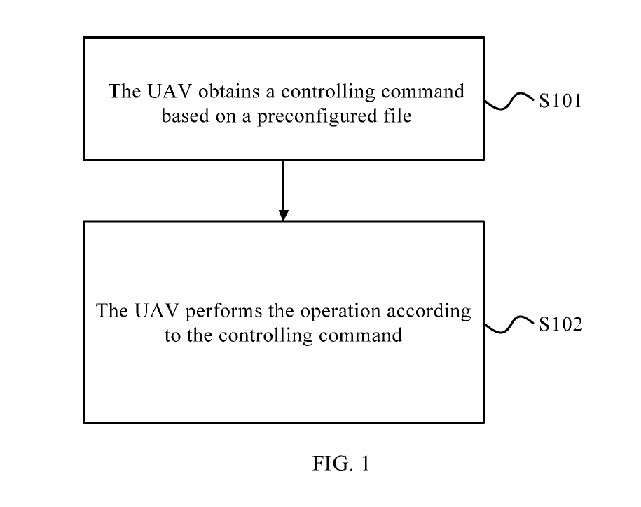

FIG. 1 is a schematic flowchart of a method for controlling a UAV according to an embodiment of the present disclosure. The executive subject matter of this method may be the UAV. As shown in FIG. 1, the method may include following steps.

S101, the UAV obtains a controlling command based on a preconfigured file.

S102, the UAV performs the operation according to the controlling command.

The preconfigured file may be generated based on a natural language, and the natural language is configured to indicate an operation of the UAV, for example, the natural language may be used by a user to describe the operation of the UAV.

In some embodiments of the disclosure, the UAV may obtain the controlling command by parsing the preconfigured file. The preconfigured file may be generated by the UAV or a controlling device which is configured to control the UAV. For example, the UAV may generate the preconfigured file based on inputs in natural language of a user at the controlling device, or the UAV may receive the preconfigured file from a controlling device and then obtain the controlling command based on the received preconfigured file. It should be noted that the process of generating the preconfigured file at the UAV is similar to that at the controlling device and the latter will be illustrated detailedly in following embodiments.

In some embodiments of the disclosure, the UAV may receive the controlling command from a controlling device, where the controlling command is obtained, by the controlling device, by parsing the preconfigured file in response to an acquired starting command.

The interactions between the UAV and the controlling device will be described in detail in following embodiments.

Since the preconfigured file is generated based on the natural language indicating the operation of the UAV, thus, the UAV may then perform the indicated operation according to the obtained controlling command.

As noted above, by obtaining the controlling command, the UAV may perform the operation according to the controlling command. Since the controlling command is generated using such natural language, a common user would be able to create a preconfigured file for UAV operations without the need for the specialty skills necessary to build a separate application to control the UAV. Thereby facilitating the control of the UAV by the user and improving the user experience.

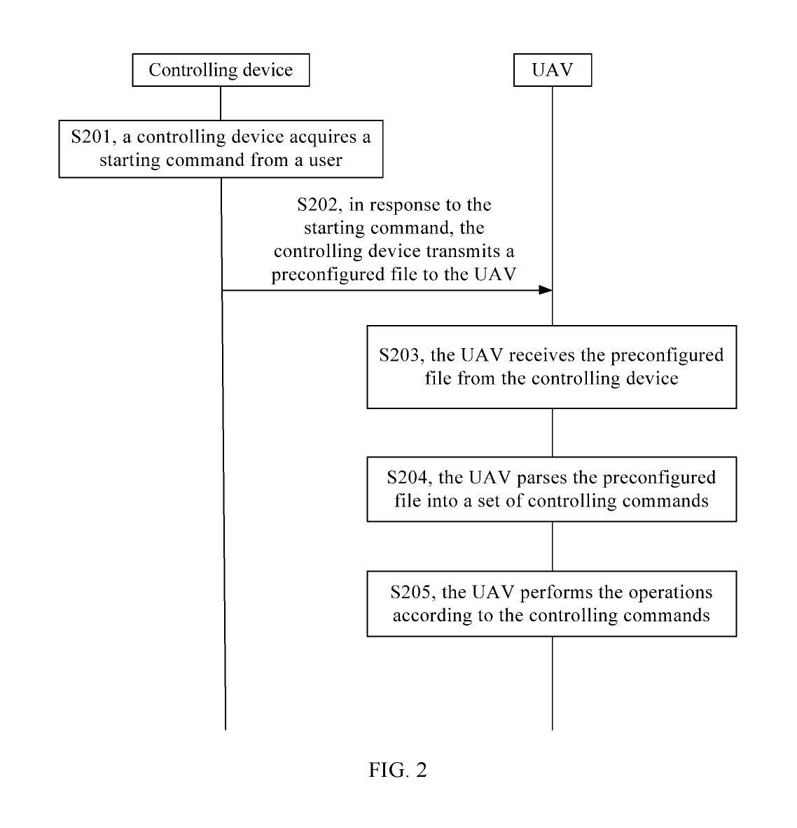

In order to describe the present disclosure more clearly, in the following, embodiments will be illustrated with reference to different interaction scenarios between the UAV and the controlling device. Before elaborating the embodiments, it would be of interest to describe the interaction scenario of these embodiments. Commonly, the UAV is controlled by a controlling device, for example, in prior art, a program may be created by a user through computer programming interfaces provided by the controlling device, and burned into the UAV, and when the program is loaded and run, the UAV may perform corresponding operations according to the program; in one optional embodiment, as shown in FIG. 2 for example, the user may also create a preconfigured file which describes operations available of the UAV at the controlling device, and the preconfigured file may be transmitted to the UAV, then the UAV may parse the preconfigured file into a set of controlling commands and execute the parsed controlling commands, or in other words, perform the corresponding operations according to the controlling commands.

FIG. 2 is a schematic flowchart of another method for controlling a UAV according to an embodiment of the present disclosure.

Specifically, the method may include following steps.

S201, a controlling device acquires a starting command from a user.

The starting command may be initiated by a user who uses the controlling device to control the UAV, and the starting command is configured to indicate the transmission of a preconfigured file.

For example, as noted above, the controlling device may be a terminal device, the user may use a controlling app installed on the controlling device to realize the control of the UAV. In this case, take the common smartphone as an example, after launching the controlling app, the user may perform a preconfigured movement, for example, touch a certain region on a touch screen of the smartphone, which may be regarded as initiating the starting command, the controlling device may then acquire the starting command from the user once detecting the user's movement.

S202, in response to the starting command, the controlling device transmits a preconfigured file to the UAV.

The user may create and save the preconfigured file for later use, when the starting command is acquired, in response, the controlling device transmits a preconfigured file to the UAV. In this way, the preconfigured file may be transmitted, loaded and executed on demand by the user. Once loaded and run, the UAV may process the natural language statements in the preconfigured file into a set of controlling commands needed to have the UAV execute the corresponding operations.

The preconfigured file is generated based on a natural language indicating operations of the UAV. As noted above, the preconfigured file may be a program including a set of statements, and the user may use the natural language to describe desired operations of the UAV. The preconfigured file may enable custom flight operations, control camera modes and settings or even generate flight commands creating flight affects. Optionally, the preconfigured file may include information about a characteristic parameter of the UAV and an instruction indicating the operation of the UAV. For example, the user may define characteristics of the camera (photo/video) and camera settings (e.g., ISO, Exposure, filter type, etc.) or the flying path of the UAV. The instruction is used for indicating the operation of the UAV, which may be all kinds of operations executable by the UAV. For example, the instruction may be to set a camera mode, to increase or decrease a flying height of the UAV, to move a position of the UAV, to take photos and etc. It should be noted that the above characteristic parameters and instructions are only for illustration and can be changed according to actual requirements.

Several examples of the preconfigured file will be presented here to facilitate the comprehension of the present disclosure.

As a first example, the preconfigured file may include the following statements: set camera ISO to 400; increase UAV altitude to 50 meters above ground level; move UAV to relative position 10 meters north; turn UAV towards the south; face camera towards pilot position 1; take photo using mode AEB; fly UAV to pilot location and land. The above statements will be parsed later by the UAV and the operations defined therein will be performed.

As a second example, the preconfigured file may include the following statements: set camera mode to AUTO, JPEG; increase UAV altitude to 50 meters above ground level; move UAV to relative position 100 meters north, 100 meters east; pause; on continue, take photos every 2 seconds until stopped; gimbal set to 50 degrees down; gimbal focus point at current location; fly orbit pattern at 20 meters, 40 meters, 60 meters; stop taking photos; fly UAV to pilot location and land.

As a third example, the preconfigured file may include the following statements: set camera ISO to 400, Exposure to +2, Focus to infinite; loop 1; gimbal set to 0 degrees down, decrease by 20 degrees per pass; loop 2 until UAV completes 360 degrees rotation; take photo; rotate aircraft 20 degrees clockwise; execute Loop 2; execute Loop 1.

As can be seen from the above examples, the user may define various operations available of the UAV using the natural language, for instance, in the first example, the user defines the ISO and the UAV altitude, and also describes the movement of the UAV. So after parsing the preconfigured file into controlling commands, the UAV may perform the desired operations according to the controlling commands. Once the preconfigured file is parsed into the controlling commands, the UAV may execute the operations as indicated in the controlling commands.

The specific process of parsing will be described in step S204. It should be noted that the specific values and operations in the above examples are merely for illustration purpose, which may be modified according to actual requirements.

Further, there are several manners for creating the preconfigured file.

In one optional implementation manner of the embodiment, the preconfigured file may be created by the controlling device before being transmitted to the UAV.

As a first optional implementation manner, the preconfigured file may be created by the controlling device based on inputs in natural language of a user. Here the inputs in natural language of the user may be selected from the group consisting of voice inputs, text inputs and gesture inputs.

Optionally, the user may use a keyboard to input statements describing the desired operations of the UAV using the natural language. Take the aforementioned controlling app as an example, the user may type the desired statements, such as “set camera ISO to 400” of the first exemplary preconfigured file into a built-in text of the controlling app, so that the controlling device may create the preconfigured file based on the inputs of the user. The user may also use a text editor to create the preconfigured file. Here the keyboard refers to the virtual keyboard displayed on the touch screen of the controlling device. It should be noted that the preconfigured file may be edited as necessary with various users (editors) as noted above.

Optionally, the user may also use, for example, a microphone to input the statements. In this way, the user may simply speak out the desired operations instead of typing, and the controlling device may generate the preconfigured file based on the words of the speaker.

Optionally, the user may also make some gestures to input the statements and the controlling device may generate the preconfigured file based on the gestures of the user.

As a second optional implementation manner, the preconfigured file may also be generated by the controlling device based on flight operations of the UAV controlled by a user. For example, the user may start a recorder and fly the UAV using a remote control, then the controlling device may record the remote control stick and physical flight operations performed by the user and automatically convert them into a set of natural language statements to generate the preconfigured file.

In another optional implementation manner, the preconfigured file may also be downloaded onto the controlling device in response to a downloading command from the user. For example, the preconfigured file may be shared by other users on the Internet, therefore, the user may simply download the preconfigured file instead of creating by himself. Optionally, the preconfigured file may be shared through a community system enabling users to share and exchange “programs” that can extend of enhance capabilities of the UAV, here the programs generally refer to the preconfigured files; or, the preconfigured file may be shared via e-mail or other social tools among users. The download operation may be as same as any download operations in prior art and will not be described detailedly herein.

S203, the UAV receives the preconfigured file from the controlling device.

S204, the UAV parses the preconfigured file into a set of controlling commands.

After receiving the preconfigured file from the controlling device, the UAV may run the preconfigured file, or in other words, the UAV may parse the received preconfigured file into the controlling commands, so as to perform corresponding operations. Here we use a set of controlling commands and corresponding operations as an example for illustration purpose, the preconfigured file may of course be parsed into a single controlling command, depending on specific operations defined by the user when generating the preconfigured file, the principle is no different and will not be repeated herein again.

As noted above, optionally, the preconfigured file may include information about a characteristic parameter of the UAV and an instruction indicating the operation of the UAV. The UAV may extract the information about the characteristic parameter of the UAV and the instruction indicating the operation of the UAV from the preconfigured file, and then converts the extracted information about the characteristic parameter of the UAV and the extracted instruction indicating the operation of the UAV into the controlling command.

As one optional implementation manner of the embodiment, the parsing operation may be performed by virtue of a traditional parser, for example, a Lex/Yacc, which may parse the statements in the preconfigured file into controlling commands readable to the UAV. Combined, a Lex/Yacc is a common method to describe a programming language. Once described the lexor may generate disclosure codes needed to parse the statements inputted in natural language in the preconfigured file into a collection of parts that have been broken down into their instruction/parameters. Once the instruction and parameters are known it is a simple operation of looping over the parts and to convert each part (instruction+parameters) into the controlling command that the UAV can understand.

Take the second exemplary preconfigured file mentioned above as an example, the statement “Set camera mode to AUTO, JPEG” may be parsed into a controlling command including an instruction “Set camera mode” and parameters “JPEG” and “AUTO”. The other statements may be parsed in a similar way and is not repeated herein.

Besides, when generating the preconfigured file using the natural language, since all languages have syntax and grammar rules, this would be no different. However, the rules may be bent in order to make them more flexible. The later depends on how the parser which may be used by the UAV to parse the preconfigured file into the controlling command is implemented. For example, as in the second exemplary preconfigured file, the statement “Set camera mode to AUTO, JPEG” may also be defined as “Camera to AUTO and JPEG” or “Mode=JPEG, Mode=AUTO”, these could be implemented to all perform the same action, although their syntax and grammar rules at very different but to the parser they all have the same component instructions and parameters. The enforcement of grammar and syntax rules is a property of the implementation. In actual implementation, the enforcement may be very strict and allow very little flexibility, or it may be much more adaptive and allow for a greater range of syntax and grammar rules. It is understood to the person skilled in the art that, the syntax and grammar rules for generating the preconfigured file may vary according to different implementation requirements of the parser.

S205, the UAV performs the operations according to the controlling commands.

Once obtaining the controlling commands parsed from the preconfigured file, the UAV may perform the operations according to the controlling command.

Optionally, as noted above, the preconfigured file may include information about a characteristic parameter of the UAV and an instruction indicating the operation of the UAV, thus, the UAV may configure the characteristic parameter of the UAV according to the extracted characteristic parameter and execute the extracted instruction in the controlling command.

Take the second exemplary preconfigured file mentioned above as an example, since the statement “Set camera mode to AUTO, JPEG” may be parsed into a controlling command including an instruction “Set camera mode” and parameters “JPEG” and “AUTO”, the UAV may then interpret this controlling command and perform a “set” (or configure) operation and as the UAV is aware of various parameters, it would know that “JPEG” means to set the image type to “JPEG” and “AUTO” means to set the exposure mode to “AUTO”. Other statements may be parsed and executed in the same way, therefore, the UAV may perform the desired operations in order through calls of the statements in the preconfigured file created by the user.

Normally, the UAV executes the steps from start to finish and in order defined by the preconfigured file. Optionally, since the preconfigured file may be paused, continued, cancelled, or repeated, correspondingly, when the preconfigured file is parsed into controlling commands, the UAV may also perform operations such as pausing, continuing, cancelling or repeating like a DVD can be controlled for videos.

As noted above, take the second exemplary preconfigured file as an example, the statement “pause” may be parsed by the UAV, and the UAV may pause after moving to a relative position which is 100 meters north and 100 meters east, and then continue to perform the subsequent operation, i.e., to take photo every 2 seconds until stopped.

Optionally, the operations for the UAV may be defined once the preconfigured file is finished. The user may also use the controlling app mentioned above in step 5201 to preview the program defined in the preconfigured file in a simulation mode.

Optionally, since there are different aircraft types, thus, in actual implementations, drone manufacturers may collaborate to create common language extensions to enable sharing of preconfigured files between different aircraft types. The preconfigured file of the present disclosure is not aircraft specific, it may be used to control any type of UAV, that is, it may be processed according to the method of the embodiment on any type of UAV, such as an unmanned multi-rotor copter or an unmanned vertical take-off and landing (VTOL) unchanged if the operations within the statements defined in the preconfigured files are compatible and supported by the different types.

It should be noted that in the above description, the preconfigured file is generated at the controlling device. Surely, as mentioned above, the preconfigured file may also be generated at the UAV. For example, the natural languages may be inputted by the user at the controlling device, and in step S202, instead of transmitting the preconfigured file, the controlling device may transmit the inputted statements to the UAV when the starting command is acquired from the user. Then the UAV may create the preconfigured file containing the statements in a way similar to that of the controlling device. For example, the UAV may create the preconfigured file base on inputs language of a user. Here the inputs in natural language of the user may be selected from the group consisting of voice inputs, text inputs and gesture inputs. The exemplary implementations are similar to those for the controlling device and are not repeated herein again. In this case, in step S203, instead of receiving the preconfigured file, the UAV may receive inputted statements from the controlling device and create the preconfigured file based on the received statements.

As noted above the main challenge to creating such programs today is the time, efforts and knowledge needed to create the app. Additionally, as the development tools evolve or the programming interface to the UAV changes additional time and efforts are needed to maintain functionality. This method, as described will create a way for common users, with limited experience to create a preconfigured file and to have it converted from an easy-to-use natural language into the controlling command needed to have the defined operations performed by the UAV. The need to learn computer languages and tools are removed, thereby saving the user many months or longer in skills learning, facilitating the control of the UAV by the user and improving the user experience.

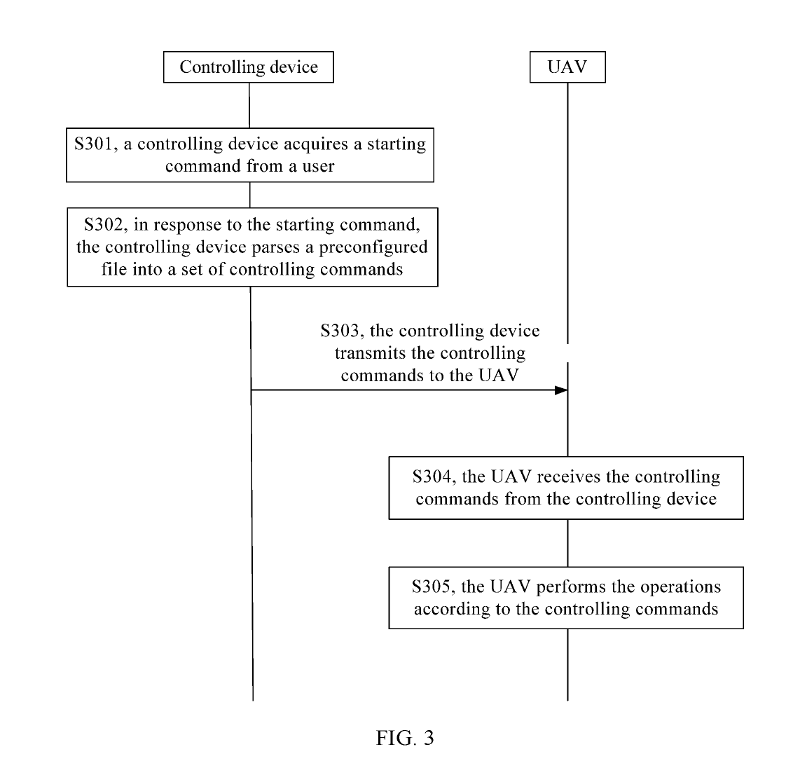

FIG. 3 is a schematic flowchart of another method for controlling a UAV according to an embodiment of the present disclosure. Different from the method shown in FIG. 2, in this interaction scenario, instead of transmitting the preconfigured file to the UAV, the controlling device may parse the preconfigured file into a set of controlling commands, and transmits the parsed controlling commands to the UAV so that the UAV may perform corresponding operations according to the controlling commands. Thus, it should be understood that in the embodiment shown in FIG. 2, the parsing operation is performed at the UAV, while in this embodiment, the parsing operation is performed at the controlling device.

Specifically, the method may include following steps:

S301, a controlling device acquires a starting command from a user.

This step is as same as the above step S201, and is not repeated herein again.

S302, in response to the starting command, the controlling device parses a preconfigured file into a set of controlling commands.

This step is similar to the above step S202, except that in this step, instead of transmitting a preconfigured file to the UAV, the controlling device per se parses the preconfigured file into the controlling commands.

The specific parsing operation of the controlling device is the same as that of the UAV in the above step 5204 and is thus not repeated herein again.

S303, the controlling device transmits the controlling commands to the UAV.

After parsing the preconfigured file into the controlling commands, the controlling device may transmit the controlling commands to the UAV.

S304, the UAV receives the controlling commands from the controlling device.

S305, the UAV performs the operations according to the controlling commands.

This step is as same as the above step S205, and is not repeated herein again.

This method, as described will create a way for common users, with limited experience to create a preconfigured file and to have it converted from an easy-to-use natural language into the controlling command needed to have the defined operations performed by the UAV. The need to learn computer languages and tools are removed, thereby saving the user many months or longer in skills learning, facilitating the control of the UAV by the user and improving the user experience. Comparing with the embodiment shown in FIG. 2, in this embodiment, the parsing operation is performed by the controlling device, thus, may also reduce the power consumption of the UAV.

In the following, device embodiments of the present disclosure, which may be used to execute the above method embodiments, will be described. Please refer to the method embodiments for details not disclosed in the following device embodiments.

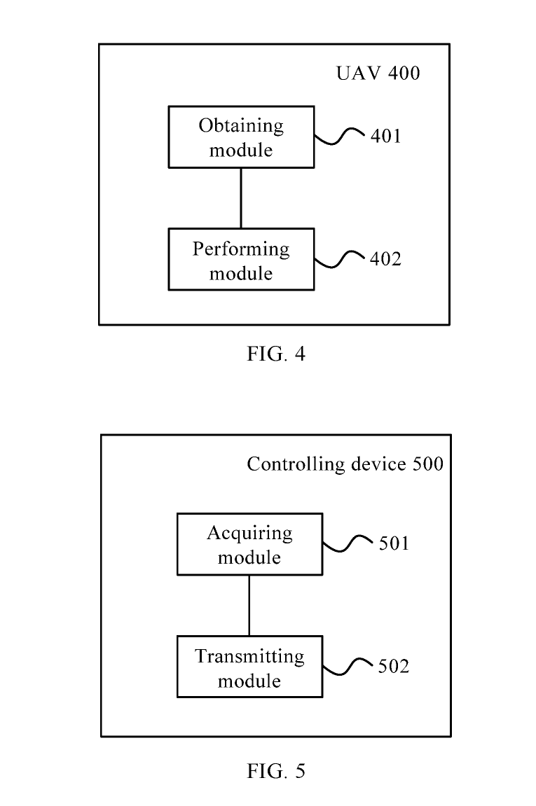

FIG. 4 is a structural explosion diagram of a UAV according to an embodiment of the present disclosure. The following modules may also be implemented as a part or entire of a UAV by electronic hardware, computer software, or a combination of electronic hardware and computer software. The UAV 400 may include: an obtaining module 401 and a performing module 402.

The obtaining module 401 is configured to obtain a controlling command based on a preconfigured file, where the preconfigured file is generated based on a natural language indicating an operation of the UAV; the performing module 402 is configured to perform the operation according to the controlling command.

Optionally, the obtaining module 401 is specifically configured to: receive the preconfigured file from a controlling device; parse the preconfigured file into the controlling command.

Optionally, the preconfigured file includes information about a characteristic parameter of the UAV and an instruction indicating the operation of the UAV; where the obtaining module 401 is specifically configured to: extract the information about the characteristic parameter of the UAV and the instruction indicating the operation of the UAV from the preconfigured file; convert the extracted information about the characteristic parameter of the UAV and the extracted instruction indicating the operation of the UAV into the controlling command.

Optionally, the obtaining module 401 is specifically configured to: receive the controlling command from a controlling device, where the controlling command is obtained, by the controlling device, by parsing the preconfigured file in response to an acquired starting command.

As noted above, by obtaining the controlling command, the UAV may perform the operation according to the controlling command. Since the controlling command is generated using such natural language, a common user would be able to create a preconfigured file for UAV operations without the need for the specialty skills necessary to build a separate disclosure to control the UAV. Thereby facilitating the control of the UAV by the user and improving the user experience.

FIG. 5 is a structural explosion diagram of a controlling device according to an embodiment of the present disclosure. The following modules may also be implemented as a part or entire of a controlling device by electronic hardware, computer software, or a combination of electronic hardware and computer software. The controlling device 500 may include: an acquiring module 501 and a transmitting module 502.

The acquiring module 501 is configured to acquire a starting command from a user; the transmitting module 502 is configured to transmit a preconfigured file in response to the starting command, where the preconfigured file is generated based on a natural language indicating an operation of the UAV.

As noted above the main challenge to creating such programs today is the time, efforts and knowledge needed to create the app. Additionally, as the development tools evolve or the programming interface to the UAV changes additional time and efforts are needed to maintain functionality. This controlling device, as described will create a way for common users, with limited experience to create a preconfigured file and to have it converted from an easy-to-use natural language into the controlling command needed to have the defined operations performed by the UAV. The need to learn computer languages and tools are removed, thereby saving the user many months or longer in skills learning, facilitating the control of the UAV by the user and improving the user experience.

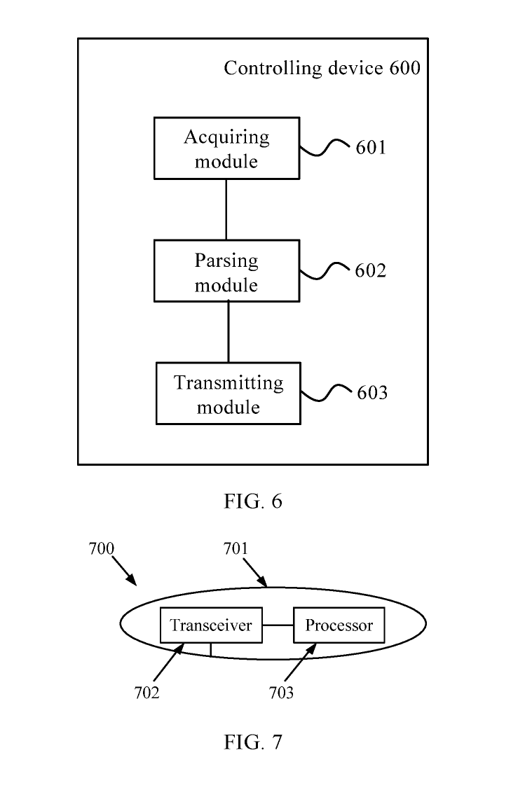

FIG. 6 is a structural explosion diagram of a controlling device according to an embodiment of the present disclosure. The following modules may also be implemented as a part or entire of a controlling device by electronic hardware, computer software, or a combination of electronic hardware and computer software. The controlling device 600 may include: an acquiring module 601, a parsing module 602 and a transmitting module 603.

The acquiring module 601 is configured to acquire a starting command from a user; the parsing module 602 is configured to parse a preconfigured file into a controlling command in response to the starting command, where the preconfigured file is generated based on a natural language indicating an operation of the UAV; the transmitting module 603 is configured to transmit the controlling command to the UAV, so that the UAV performs the operation according to the controlling command.

This controlling device, as described will create a way for common users, with limited experience to create a preconfigured file and to have it converted from an easy-to-use natural language into the controlling command needed to have the defined operations performed by the UAV. The need to learn computer languages and tools are removed, thereby saving the user many months or longer in skills learning, facilitating the control of the UAV by the user and improving the user experience. Further, since the parsing operation is performed by the controlling device, thereby the power consumption of the UAV is reduced.

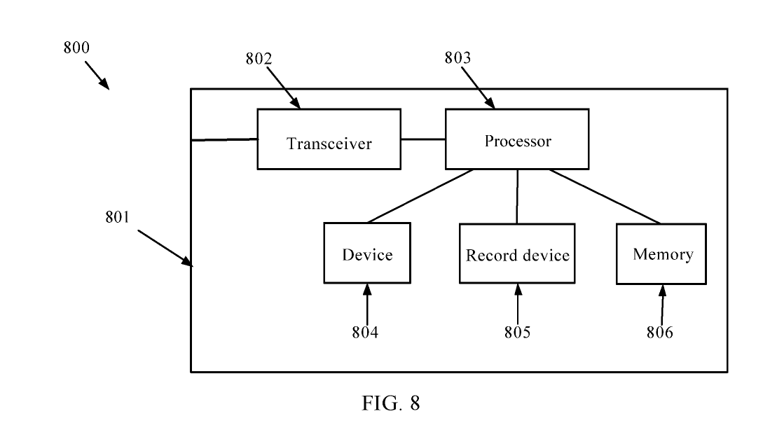

FIG. 7 is a structural diagram of a UAV according to an embodiment of the present disclosure. The UAV 700 may include: an airframe 701, a transceiver 702 and a processor 703.

The transceiver 702 is coupled to the airframe 701 and is configured to obtain a controlling command based on a preconfigured file, wherein the preconfigured file is generated based on a natural language indicating an operation of the UAV; and the processor 703 is coupled to the transceiver 702 and is configured to perform the operation according to the controlling command.

Optionally, the processor 702 is further configured to: receive the preconfigured file from a controlling device; parse the preconfigured file into the controlling command.

Optionally, the preconfigured file comprises information about a characteristic parameter of the UAV and an instruction indicating the operation of the UAV; where the processor 702 is configured to: extract the information about the characteristic parameter of the UAV and the instruction indicating the operation of the UAV from the preconfigured file; convert the extracted information about the characteristic parameter of the UAV and the extracted instruction indicating the operation of the UAV into the controlling command.

Optionally, the processor 702 is configured to receive the controlling command from a controlling device, wherein the controlling command is obtained, by the controlling device, by parsing the preconfigured file in response to an acquired starting command.

As noted above, by obtaining the controlling command, the UAV may perform the operation according to the controlling command. Since the controlling command is generated using such natural language, a common user would be able to create a preconfigured file for UAV operations without the need for the specialty skills necessary to build a separate disclosure to control the UAV. Thereby facilitating the control of the UAV by the user and improving the user experience.

FIG. 8 is a structural diagram of a controlling device according to an embodiment of the present disclosure. The controlling device 800 may include: a shell 801, a transceiver 802 and a processor 803.

Optionally, the transceiver 802 is coupled to the shell and is configured to acquire a starting command from a user and the processor 803 is configured to parse a preconfigured file into a controlling command in response to the starting command, where the preconfigured file is generated based on a natural language indicating an operation of the UAV; where the transceiver 802 is further configured to transmit the controlling command to the UAV, so that the UAV performs the operation according to the controlling command.

Optionally, the preconfigured file comprises information about a characteristic parameter of the UAV and an instruction indicating the operation of the UAV; where the processor 803 is configured to: extract the information about the characteristic parameter of the UAV and the instruction indicating the operation of the UAV from the preconfigured file; convert the extracted information about the characteristic parameter of the UAV and the extracted instruction indicating the operation of the UAV into the controlling command.

Optionally, the controlling device 800 further includes a device 804 configured to perform the controlling command in a simulation mode.

Optionally, the controlling device 800 further includes a record device 805. In one optional implementation manner, the record device 805 is configured to record physical operations performed by a user, wherein the processor 803 is configured to convert the physical operations into the natural language; in another optional implementation manner, the record device 805 is configured to record the operation performed by the UAV according to the controlling command.

Optionally, the controlling device 800 further includes a memory 806 configured to store the controlling command.

This controlling device, as described will create a way for common users, with limited experience to create a preconfigured file and to have it converted from an easy-to-use natural language into the controlling command needed to have the defined operations performed by the UAV. The need to learn computer languages and tools are removed, thereby saving the user many months or longer in skills learning, facilitating the control of the UAV by the user and improving the user experience. Further, since the parsing operation is performed by the controlling device, thereby the power consumption of the UAV is reduced.

Further, the present disclosure also provides a controlling device, including: a non-transitory computer readable storage medium, including computer program codes when executed by a computer processor causing the compute processor to execute steps of the method according to any one of the embodiments shown in FIG. 2.

Further, the present disclosure also provides a controlling device, including: a non-transitory computer readable storage medium, including computer program codes when executed by a computer processor causing the compute processor to execute steps of the method according to any one of the embodiments shown in FIG. 3.

These are only embodiments of the present disclosure; but not intended to limit the scope of the present disclosure. The equivalent structure or equivalent process transformation which is made by using the description and the accompanying drawings of the present disclosure and is directly or indirectly applied to other related technical areas, are all equally included in the patent protection scope of the present disclosure.

Finally, it should be noted that the foregoing embodiments are merely intended to describe the technical solutions of the present disclosure other than limit the present disclosure. Although the present disclosure is described in detail with reference to the foregoing embodiments, a person of ordinary skill in the art should understand that he may still make modifications to the technical solutions described in the foregoing embodiments, or make equivalent replacements to some or all technical features thereof, and such modification and replacement cannot make the essence of the corresponding technical solutions depart from the scope of the technical solutions of the embodiments of the present disclosure.

What is claimed is:

1. A method for controlling an unmanned aerial vehicle (UAV), comprising:
obtaining, by the UAV, a controlling command based on a preconfigured file, wherein the preconfigured file is generated based on a natural language indicating an operation of the UAV;
performing, by the UAV, the operation according to the controlling command.

2. The method according to claim 1, wherein the obtaining, by the UAV, a controlling command based on a preconfigured file comprises:
receiving, by the UAV, the preconfigured file from a controlling device;
parsing, by the UAV, the preconfigured file into the controlling command.

3. The method according to claim 2, wherein the preconfigured file comprises information about a characteristic parameter of the UAV and an instruction indicating the operation of the UAV;
wherein the parsing, by the UAV, the preconfigured file into the controlling command comprises:
extracting, by the UAV, the information about the characteristic parameter of the UAV and the instruction indicating the operation of the UAV from the preconfigured file;
converting, by the UAV, the extracted information about the characteristic parameter of the UAV and the extracted instruction indicating the operation of the UAV into the controlling command.

4. The method according to claim 1, wherein the obtaining, by the UAV, a controlling command based on a preconfigured file comprises:
receiving, by the UAV, the controlling command from a controlling device, wherein the controlling command is obtained, by the controlling device, by parsing the preconfigured file in response to an acquired starting command.

5. The method according to claim 1, wherein the preconfigured file is generated by a controlling device or the UAV based on inputs in natural language of a user.

6. The method according to claim 5, wherein the inputs in natural language of the user are selected from the group consisting of voice inputs, text inputs and gesture inputs.

7. The method according to claim 1, wherein the preconfigured file is generated by a controlling device or the UAV based on flight operations of the UAV controlled by a user. 8 The method according to claim 1, wherein the preconfigured file is downloaded by a controlling device or the UAV in response to a downloading command from a user.

9. A method for controlling an unmanned aerial vehicle (UAV), comprising:
acquiring, by a controlling device, a starting command from a user;
in response to the starting command, transmitting, by the controlling device, a preconfigured file, wherein the preconfigured file is generated based on a natural language indicating an operation of the UAV.

10. A method for controlling an unmanned aerial vehicle (UAV), comprising:
acquiring, by a controlling device, a starting command from a user;
in response to the starting command, parsing, by the controlling device, a preconfigured file into a controlling command, wherein the preconfigured file is generated based on a natural language indicating an operation of the UAV;
transmitting, by the controlling device, the controlling command to the UAV, so that the UAV performs the operation according to the controlling command.

11. An unmanned aerial vehicle (UAV), comprising:
an airframe,
a transceiver coupled to the airframe and configured to obtain a controlling command based on a preconfigured file, wherein the preconfigured file is generated based on a natural language indicating an operation of the UAV; and
a processor coupled to the transceiver and configured to perform the operation according to the controlling command.

12. The unmanned aerial vehicle according to claim 11, wherein the processor is further configured to:
receive the preconfigured file from a controlling device;
parse the preconfigured file into the controlling command.

13. The unmanned aerial vehicle according to claim 12, wherein the preconfigured file comprises information about a characteristic parameter of the UAV and an instruction indicating the operation of the UAV;
wherein the processor is configured to:
extract the information about the characteristic parameter of the UAV and the instruction indicating the operation of the UAV from the preconfigured file;
convert the extracted information about the characteristic parameter of the UAV and the extracted instruction indicating the operation of the UAV into the controlling command.

14. The unmanned aerial vehicle according to claim 11, wherein the processor is configured to receive the controlling command from a controlling device, wherein the controlling command is obtained, by the controlling device, by parsing the preconfigured file in response to an acquired starting command.

15. A controlling device, comprising:
a shell;
a transceiver coupled to the shell and configured to acquire a starting command from a user and
a processor configured to parse a preconfigured file into a controlling command in response to the starting command, wherein the preconfigured file is generated based on a natural language indicating an operation of the UAV;
wherein the transceiver is further configured to transmit the controlling command to the UAV, so that the UAV performs the operation according to the controlling command.

16. The controlling device according to claim 15, wherein the preconfigured file comprises information about a characteristic parameter of the UAV and an instruction indicating the operation of the UAV;
wherein the processor is configured to:
extract the information about the characteristic parameter of the UAV and the instruction indicating the operation of the UAV from the preconfigured file;
convert the extracted information about the characteristic parameter of the UAV and the extracted instruction indicating the operation of the UAV into the controlling command.

17. The controlling device according to claim 15, further comprising: a device configured to perform the controlling command in a simulation mode.

18. The controlling device according to claim 15, further comprising: a record device configured to record physical operations performed by a user, wherein the processor is configured to convert the physical operations into the natural language.

19. The controlling device according to claim 15, further comprising: a record device configured to record the operation performed by the UAV according to the controlling command.

20. The controlling device according to claim 15, further comprising: a memory configured to store the controlling command.
